(19) United States
(12) Patent Application Publication
(10) Pub. No.: US 2008/0148349 A1
(43) Pub. Date: Jun. 19, 2008

(54) Authorization to use content

(76) Inventors: Nicholas D. Stevens, Corvallis, OR (US); Gabriel B. Beged-Dov, Corvallis, OR (US); Russell Mull, Corvallis, OR (US); Jonathan J. Sandoval, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/588,084

(22) Filed: Oct. 26, 2006

(51) Int. Cl. G06F 17/30

(52) U.S. Cl. 726/2

(57) ABSTRACT

A rights manager includes a database and a rights server. The database contains information pertaining to a content user. The information includes a separate identification for each device of a content user authorized to use content. The rights server interacts with the database, so that when the rights server receives a request for authorization to use content by a first device of a content user, the rights server matches a first identification stored on the first device with identification information stored in the database to identify the first device and the content user. When the rights server grants the authorization, the first identification is replaced with a new identification. The new identification is different than the first identification. The new identification is stored in the content user database and in the first device. The new identification is used to identify the first device and the content user in a next interaction between the first device and the rights server.

### BACKGROUND

When media content is sold or licensed over the internet, protection mechanisms can be used in order to prevent, or at least discourage, illegitimate use of the media content.

For example, media content can be formatted or encrypted so that only specific types of media players with built-in security features installed on a content user's device are able to play the content. For example, when asked to play a media file, a media player can contact a centralized licensing source that can determine whether a user has authorization to play the media file. The centralized licensing source can authorize each play of the media file, or can issue a limited authorization that allows the media player to play the media file a certain number of time or for a certain period of time, such as a specific number of days. Alternatively, an unlimited authorization can be granted that allows unlimited play of the media file without the need to check back with the centralized licensing source.

Whenever the media player contacts the centralized licensing source, it is desirable that the centralized licensing source be able to identify the media player with a user and determine which media files a particular user is licensed to play or otherwise use. Identification can require user action such as typing in an identity and a password. However, frequently requiring a user to type in information can be burdensome to the user.

Alternatively, identification of a user associated with a media player can be done passively, using identification information stored within the media player or elsewhere on the device. However, a centralized licensing source may not be able to obtain identification information from some types of media players. Identification information stored elsewhere on the device may be stored insecurely and available to be obtained and misused by non-licensees of media files.

It is desirable, therefore to create a secure way of authorizing users to play content in a media player, while maintaining a good user experience.

### BRIEF DESCRIPTION OF THE DRAWINGS

FIG. 1 is a simplified block diagram showing a system that provides authorization to use content in accordance with an embodiment of the present invention.

FIG. 2 is a simplified flowchart illustrating authorization to use content in accordance with an embodiment of the present invention.

FIG. 3, FIG. 4, FIG. 5 and FIG. 6 illustrate screens potentially displayed to a user when the user attempts to obtain authorization to use content in accordance with an embodiment of the present invention.

FIG. 7 is another simplified flowchart illustrating authorization to use content in accordance with an embodiment of the present invention.

FIG. 8 is a simplified flowchart illustrating authorization to use content being invalidated on the device of an unauthorized user in accordance with an embodiment of the present invention.

FIG. 9 is another simplified flowchart illustrating authorization to use content in accordance with an embodiment of the present invention.

FIG. 10 is a simplified block diagram that illustrates content delivery from multiple full clients to a light client in accordance with an embodiment of the present invention.

### DESCRIPTION OF THE EMBODIMENT

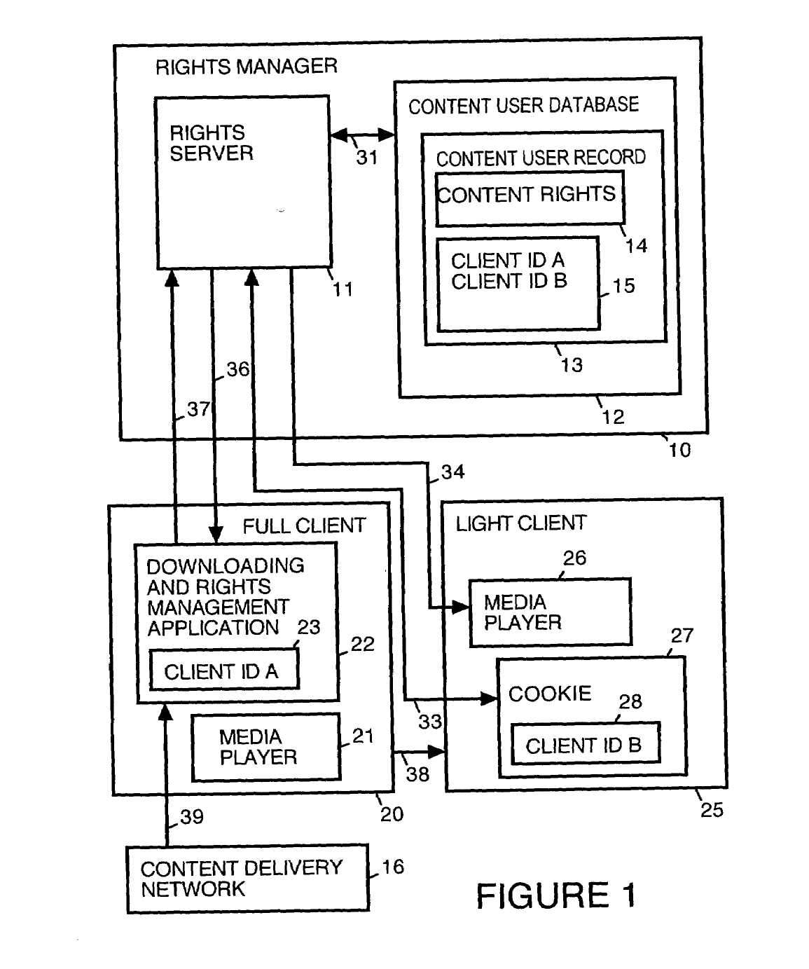

FIG. 1 is a simplified block diagram showing a system that provides authorization to use content. The use of content includes, for example, playing video content, playing audio content, displaying picture content or any other way content can be used by a content user.

A rights manager 10 is, for example, a digital rights management licensing system accessible using the internet. Alternatively, rights manager can be any type of entity that can grant authorization to use content. In addition to communication by the internet, rights manager 10 could be accessible using another network or communications technology. For example, rights manager 10 includes a rights server 11 and a content user database 12. Rights server 11 and content user database 12 can, for example, reside in the same or on different computer systems. Within database 12 are various content user records. For example, a content user record 13 includes content rights 14 that indicate what rights a content user has to what content. In addition, content user record 13 includes a separate identification for each device of a content user that is authorized to use content. The separate identification for each device is a client identifier (ID) for each client of the content user that is authorized to use content. For example, in an area 15, content user record 13 stores a client ID A and a client IDB.

A full client 20 is, for example, a device owned by a content user of content. The device can be a desktop computer, a laptop computer, a personal digital assistant, a miniature digital player, a cell phone, or any other device that can include a media player. Full client 20 is called “full” because full client contains a downloading and rights management application 22 in addition to a media player 21. Within a storage area 23 controlled by full client 22 there is stored client ID A. For example, downloading and rights management application 22 stores client ID A in such a way that it is protected from illegitimate copy and use. Full client 20 can use client ID A as an identification to rights manager 10 to identify itself to rights manager 10.

The content user, as a user of full client 20, can obtain content in a number of ways. For example, FIG. 1 shows full client 20 obtaining content from a content delivery network 16 through a connection 39. For example, content delivery network 16 could be a web site and connection 39 could represent the internet. Alternatively, full client 20 could obtain the content by transfer from a friend's computer, storage media or by some other means. The content is, for example, any information that contains content. For example the content is stored in files. The files could be a Windows Media Video (WMV) files configured to play in Windows Media Player. Alternatively, the files could be media files that are configured to play on a Quicktime player, a Realplayer, or some other type of media player. Media player 21 shown in FIG. 1 is, for example a Windows Media Player, a Quicktime media player, a Realplayer media player, or some other type of media player that is able to play, display or otherwise use content such as audio, video, still picture and so on.

When the content user attempts to use the content using media player 21 within full client 20, media player 21 may detect that the content is protected. At this point media player 21 checks to see whether the content user has authorization to use the content on the full client.

For example, media player 21 may store such authorizations internally. If so, once media player 21 determines the content user has authorization to use the content on full client 22, media player 21 uses the content. The authorization may be in the form of a license or some other form of confirmation that the content user is authorized to use the content on full client 22. For example, authorization may be in the form of playback licensing as in Windows Media Digital Rights Management.

Alternatively, downloading and rights management application 22 may store such authorizations. If so, once downloading and rights management application 22 determines the content user has authorization to use the content on full client 22, downloading and rights management application 22 authorizes media player 21 to use the content.

If an authorization to use the content does not already reside in media player 21 or downloading and rights management application 22, downloading and rights management application 22 can contact rights server 11 to see if the content user has authorization to use the content on full client 22. This request is represented in FIG. 1 by an arrow 37. The request to determine authorization can also include client ID A in order to identify full client 20.

Upon receiving the request, rights server 11 can access content user database 12 to see what content rights are associated with client ID A. This interaction between rights server 11 and content user database 12 is represented in FIG. 1 by arrow 31. Rights server 11 can then communicate to download rights management application 22 whether the content user has authorization to use the content on full client 22. This is represented by an arrow 36. If so, media player 21 plays the content. If not, the content user can be offered the option to purchase the needed authorization. The authorization can come, for example, as a limited authorization, limited, for example, by the number of plays or by a set period of time, or as an authorization for unlimited use on full client 20.

The content user can transfer content from full client 20 to a light client 25. This is represented in FIG. 1 by arrow 28. Content can also be obtained by light client 25 in other ways such as through a website or transfer from another source such as another full client or another entity that is able to obtain and store content. Light client 25 is, for example, a device owned by a content user of content. The device can be a desktop computer, a laptop computer, a personal digital assistant, a miniature digital player, a cell phone, or any other device that can include a media player. Light client 25 is called a light client because light client 25 includes a media player 26, but does not include a separate downloading and rights management application.

When the content user attempts to use the content using media player 26 within light client 25, media player 26 may detect that the content is protected. At this point media player 26 checks to see whether the content user has authorization to use the content on the light client.

For example, media player 26 may store such authorizations internally. If so, once media player 26 determines the content user has authorization to use the content on light client 22, media player 26 plays the content. For example, authorization may be in the form of playback licensing as in Windows Media Digital Rights Management. Alternatively, another application within light client can store authorizations.

If an authorization to use the content does not already reside in media player 26 or in some other application within light client 25, media player 26 or some other entity within light client 25 contacts rights server 11 to see if the content user has authorization to use the content on light client 22. If light client 25 has a client ID, the request to determine authorization can also include the client ID in order to identify light client 25.

For example, FIG. 1 shows client ID B stored in a memory location 28 within a cookie 27. For example, cookie 27 is an internet cookie stored on light client 25. Alternatively, client ID B can be stored in another secure or insecure location within light client 25.

For example, when the new client ID is stored in an internet cookie, the internet cookie can be created like any other cookie is created on the light client. All the usual cookie rules can apply. For example, the creator of the cookie may be required to be from the same domain as its eventual consumer. In this case, when receiving a cookie, a user of light client 25 (i.e., the content user) visits a webpage at some point that is in the same domain as the rights server. Light client 25 is, for example, redirected to this webpage from a secure page that knows the content user accesses the webpage. The webpage requests a username and password for the consumer. There the content user is allowed to give light client 25 a human readable name for reference. This will allow the content user to later disapprove a device for playback of particular content, since the number of devices on which particular content can be used is typically limited. Alternatively, the internet cookie can be created by software residing on the light client that knows how to manipulate the local cookie storage to create an internet cookie.

Upon receiving the request, rights server 11 can access content user database 12 to see what content rights are associated with client ID B. Rights server 11 can then communicate to media player 26 or another entity within light client 25 whether the content user has authorization to use the content on light client 22. This is represented in FIG. 1 by an arrow 34. If so, media player 26 plays the content. If not, the content user can be offered the option to purchase the needed authorization. The authorization can come, for example, as an authorization limited, for example, by the number of plays or by a set period of time or as an authorization for unlimited use on light client 25. Security against misuse of content can be increased by granting only limited authorization, as will be further illustrated below. The interaction between media player 26 and rights server is represented by an arrow 36.

In order to help provide protection, rights server 11 forwards a new client ID that is stored by light client 25. This is represented in FIG. 1 by an arrow 33. The new client ID replaces any existing client ID stored by light client 25. For example, the new client ID replaces client ID B in memory location 28.

While rights server 11 can replace the client ID for each interaction with light client 25, it is not typically necessary to change client ID when there is an interaction with full client ID 20. This is because full client 20 is able to store client ID A in a secure location safe from outside access. However, light client 25 may store client ID B in an unsecured memory location, such as an internet cookie, where client ID B can be accessed by an unauthorized user of the content. Therefore, in one embodiment of the invention rights server 11 replaces client ID B after an interaction with light client 25, but does not replace client ID A after an interaction with full client 20. This allows client ID A to be a permanent, unchanging identification of full client 20.

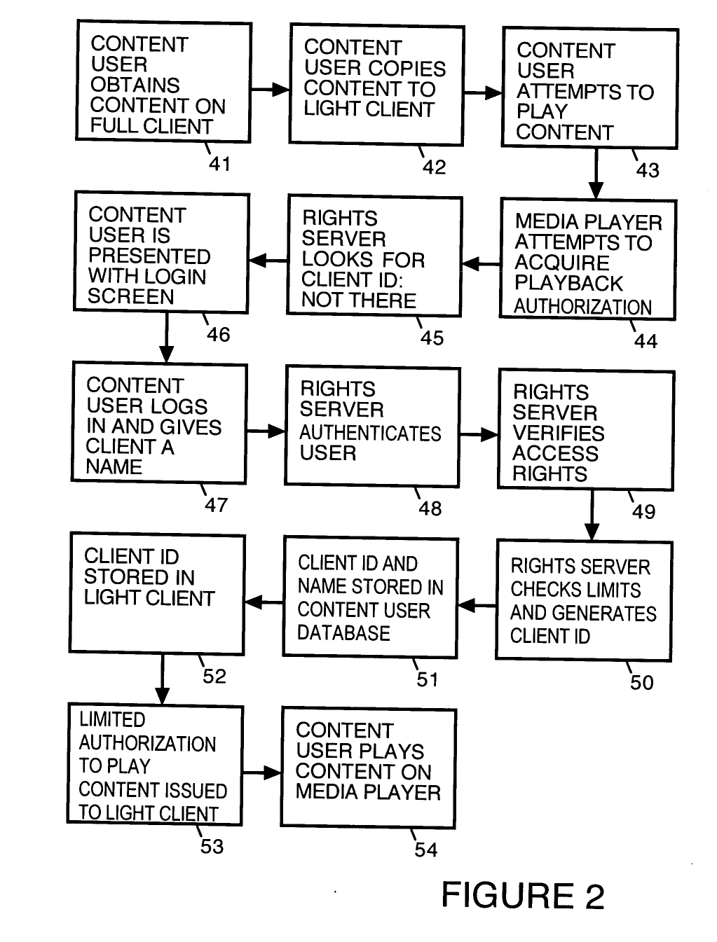

FIG. 2 is a simplified flowchart illustrating a scenario in which a content user loads content to a light client and obtains authorization to use the content.

In a block 41, the content user obtains content on a full client. In a block 42, the content user copies the content to a light client. In a block 43, the content user attempts to use the content, for example, using a media player. In a block 44, the media player attempts to acquire playback authorization. In a block 45, the right server looks for a client ID. In this scenario, there is no client ID on the light client. In a block 45, the content user is presented with a login screen that appears on a display of the light client.

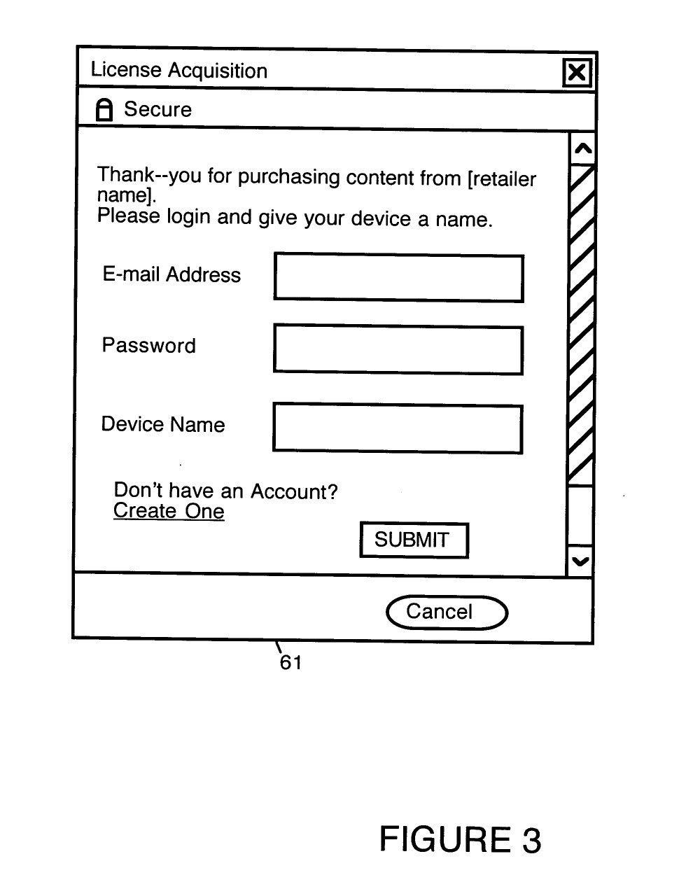

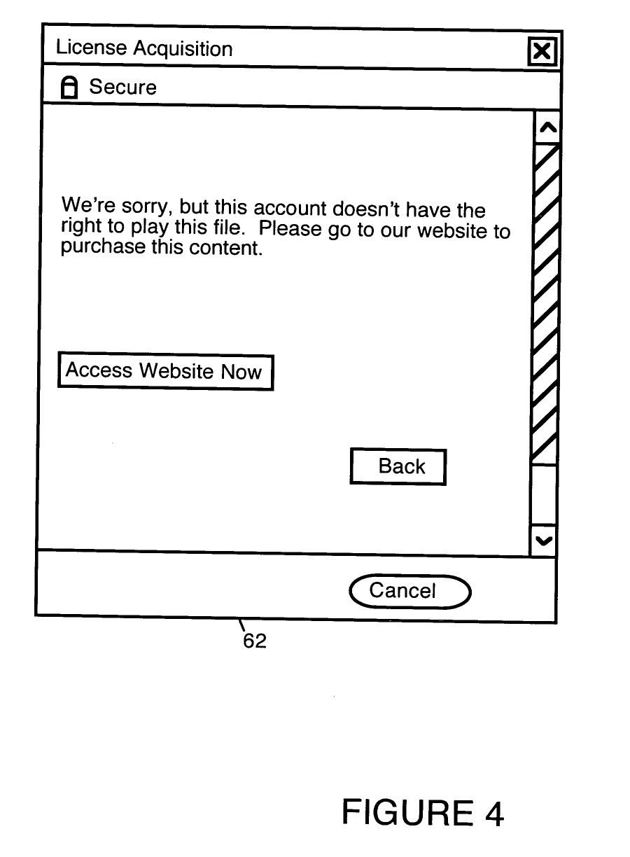

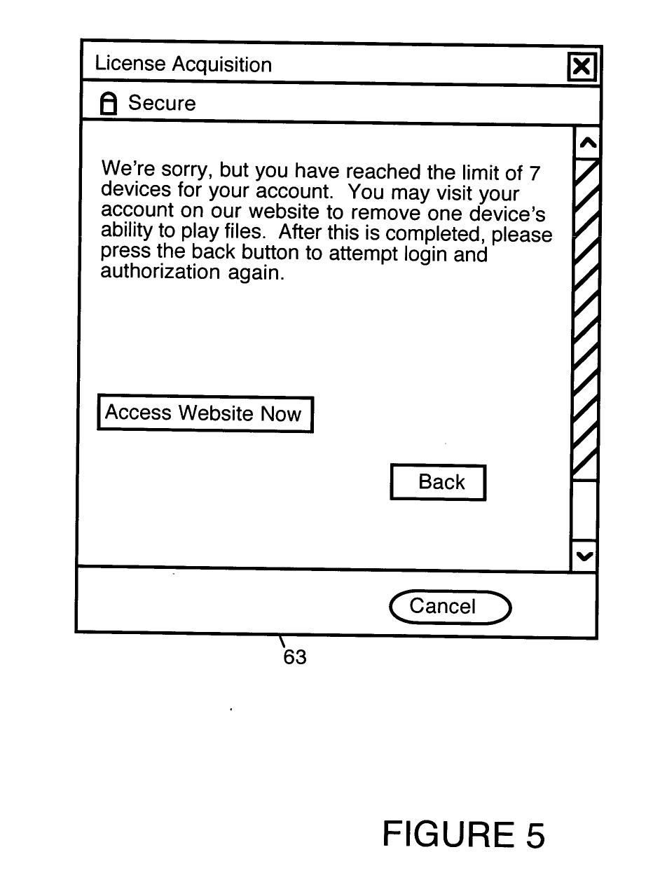

FIG. 3 shows an example of a login screen 61 that appears on the display of the light client. This login screen 61 can be generated by the light client, or generated by a webpage or other entity originating from the rights server. Login screen 61 requests a user to log in using an e-mail address and password. The login information requested in login screen 61 is only exemplary as other types of login information, such as a name or other identifier could be used. Login screen 61 also requests the user to give the device a name.

In a block 47, shown in FIG. 2, the content user logs in and gives the light client a name. In a block 48, the rights server authenticates the content user is a registered user. In a block 49, the rights server verifies the content user has access rights to the content.

If the rights server determines that the content user does not have access rights to the content, the light client can be instructed to inform the content user of the lack of rights and invite the content user to purchase the content. This is done, for example, by a screen such as a screen 62 shown in FIG. 4.

If the rights server confirms the content user has access rights to the content, in a block 50, shown in FIG. 2, the rights server checks limits and generates a new client ID. Checking limits may include, for example, checking to see how many other clients are registered for a content user. For example, a client may be limited to playing the content on a specified number of clients. The specified number may be 1, 2, 3, 4 or any other preselected number. If the limit of clients is exceeded, the content user can be informed that the number has been exceeded. This is done, for example, by a screen such as a screen 63 shown in FIG. 5. For the example illustrated by screen 63, the specified number of clients is seven.

In a block 51, a new client ID and the device name are stored in a content user record for the content user within the content user database associated with the rights server. This allows the right server to identify the light client with the content user. In a block 52, the new client ID is stored on the light client. For example, the new client ID is stored in a cookie, or in some other location on the light client.

In a block 53, a limited authorization is issued to the light client to use the now authorized content. The authorization is limited, for example, by a number of plays of the content, or by a time period. For example, the content user can be informed of the limited authorization. This is done, for example, by a screen such as a screen 64 shown in FIG. 6. For the example illustrated by screen 64 the limited authorization is for 10 days and a maximum of five devices of the content user can be authorized to use the content.

In a block 54, shown in FIG. 2, the content user plays the content on the media player within the light client.

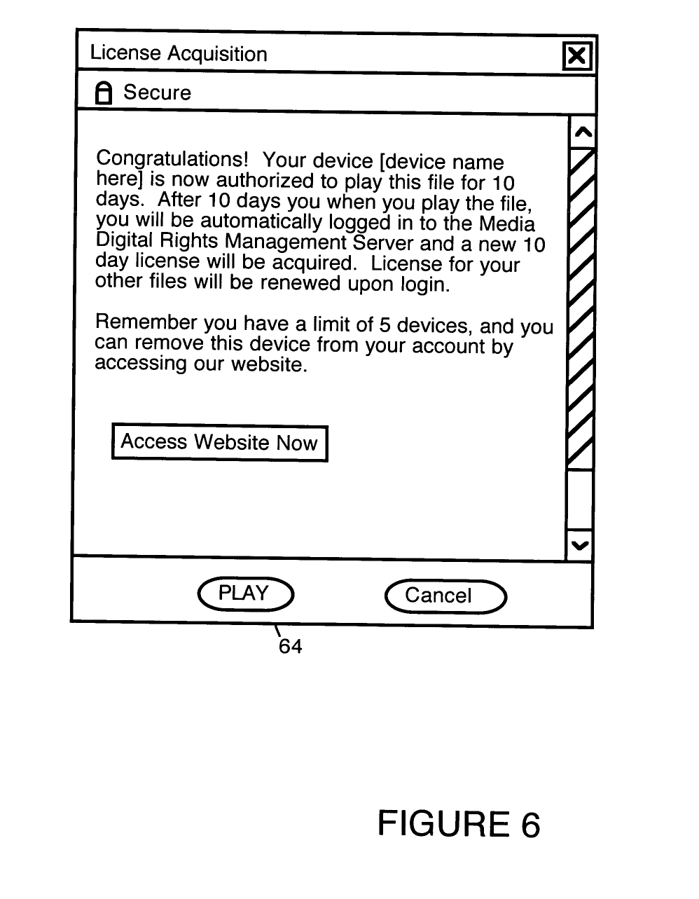

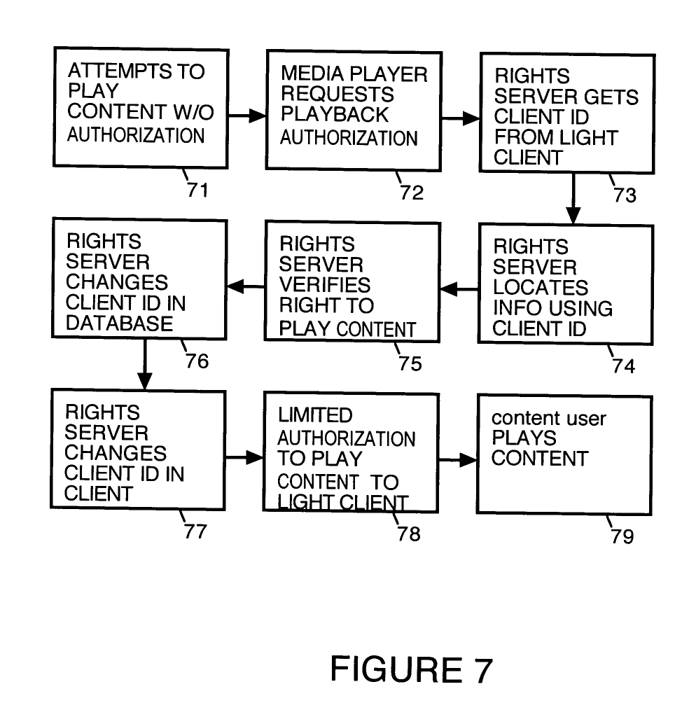

FIG. 7 is a simplified flowchart illustrating another scenario in which attempts to use content on a light client. In a block 71, the content user attempts to use content on a media player within a light client. The light client is not currently authorized to use the content. In a block 72, the media player contacts a rights server and requests playback authorization. In a block 73, the right server obtains a client ID from the light client. For example, the client ID is stored within a cookie within the light client. Alternatively, the client ID is stored in another location within the light client.

In a block 74, the rights server locates information on the content user and the light client using the client ID. In a block 75, the rights server verifies the content user has authorization to use the content.

In a block 76, the client ID stored in a content user record within the content user database associated with the rights server is changed to a new client ID. In a block 77, the client ID stored in the light client is changed to the new client ID. For example, the new client ID is stored in a cookie, or in some other location within the light client.

In a block 78, a limited authorization is issued to the light client to use the now authorized content. The authorization is limited, for example, by a number of plays of the content, or by a time period. In a block 79, the content user plays the content on the media player within the light client.

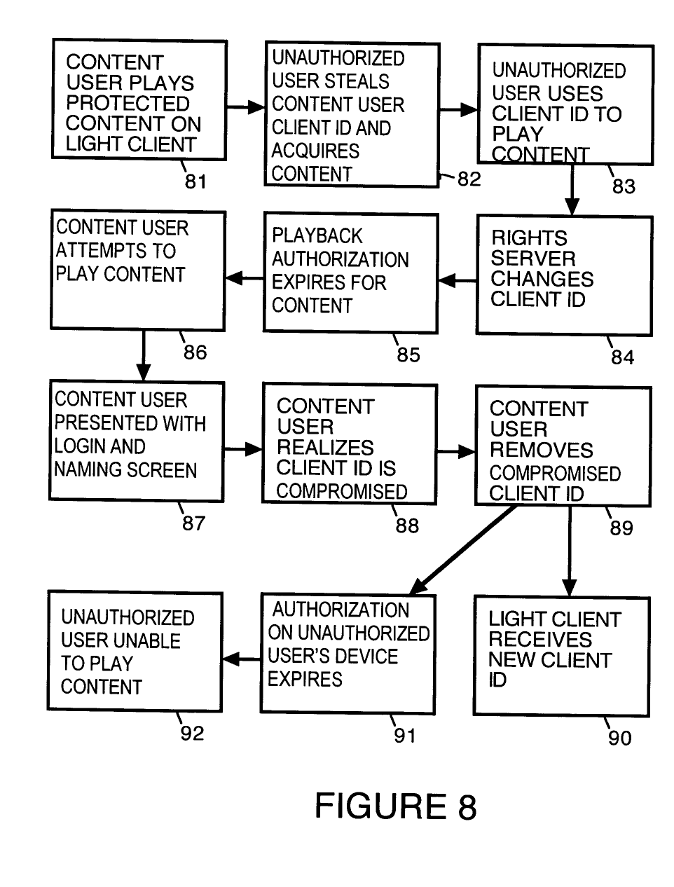

FIG. 8 is a simplified flowchart illustrating authorization to use content being invalidated on the device of an unauthorized user. In a block 81, the content user plays the content on the media player within a light client. In a block 82, an unauthorized user, such as a hacker, obtains the client ID stored on the light client. In a block 83, the unauthorized user uses the client ID to use content on a media player within the unauthorized user's device. In a block 84, the rights server changes the client ID. This occurs, for example, when the media player of the unauthorized user's device accesses the rights server for authorization to use the content. Now, the client ID stored on the unauthorized user's device is a valid client ID, while the client ID stored on the light client of the content user is invalid.

In a block 85, the playback authorization within the media player within the light client for the content expires. In a block 86, the content user next attempts to use the content, however, the authorization within the media player is expired. The media player within the light client sends the client ID within the light client to the rights server. However, the client ID is invalid. In a block 87, the light client presents the content user with a login and naming screen such as screen 61 shown in FIG. 3. In a block 88, the content user realizes the client ID is compromised. In a block 89, the client accesses the website for the rights server and instructs the rights server to remove the compromised client ID from the content user record (within the content user database) for the content user.

In a block 90, the light client receives a new client ID. Now, the client ID stored on the light client of the content user is a valid client ID, while the client ID stored on the unauthorized user's device is invalid. In a block 91, the playback authorization within the media player within the unauthorized user's device for the content expires. In a block 92, when the unauthorized user's device next attempts to use the content, the authorization within the media player is expired. The unauthorized user is not able to use the content until the unauthorized user purchases or otherwise obtains authorization.

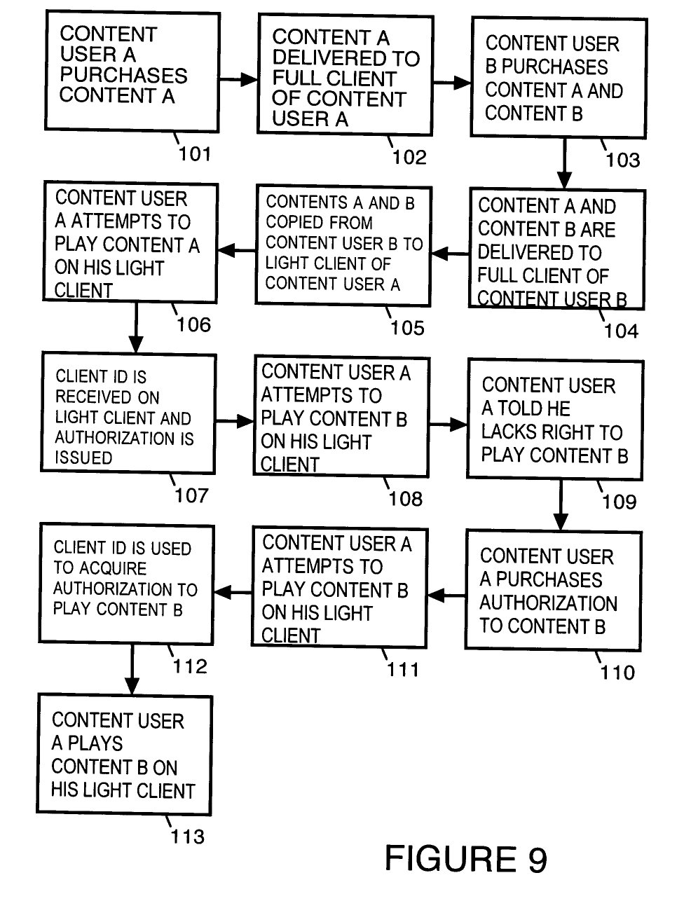

FIG. 9 is a simplified flowchart illustrating a scenario in which a content user obtains and plays content. In a block 101, a first content user, referred to as content user A, purchases first content, referred to as content A. In a block 102, content A is delivered to a full client of content user A. In a block 103, a second content user, referred to as content user B, purchases content A and second content, referred to as content B. In a block 104, content A and content B are delivered to a full client of content user B.

In a block 105, content A and content B are copied from the full client of content user B to a light client of content user A. In a block 106, content user A attempts to use content A on his light client. In a block 107, the light client receives from a rights server a client ID and authorization is issued that allows content user A to use content A on the light client of content user A.

In a block 108, content user A attempts to use content B on content user A's light client. In a block 109, the light client receives from a rights server an indication that content user A lacks authorization to use content B. In a block 110, content user A purchases authorization to content B. In a block 111, content user A again attempts to use content A on the light client of content user A. In a block 112, the light client sends a request for authorization to use content B. The request for authorization includes the current client ID residing on the light client of content user A. The rights server returns authorization to use content B along with a new client ID, which is stored on the light client of content user A. In a block 113, content user A plays content B on his light client.

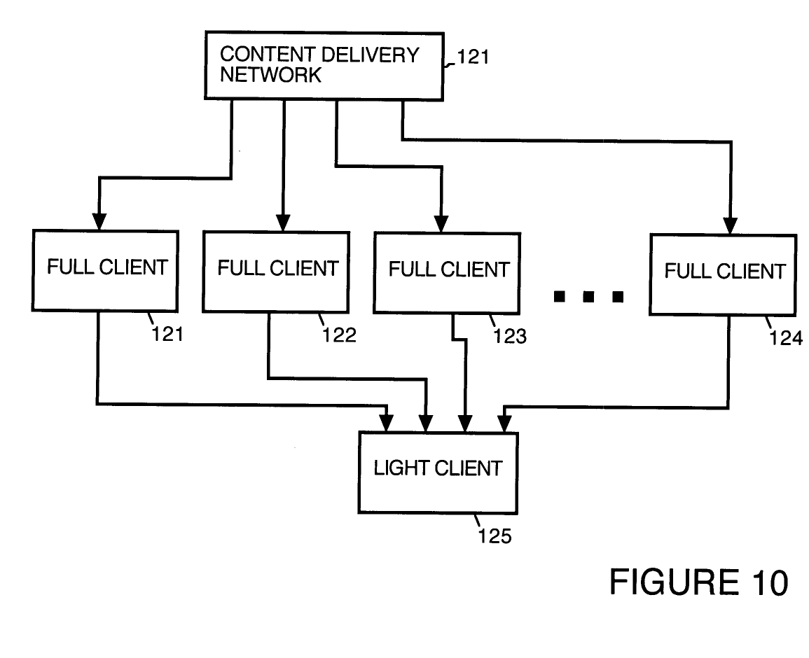

FIG. 10 is a simplified block diagram that illustrates content delivery from multiple full clients to a single light client. Numerous clients, represented in FIG. 10 by a full client 121, a full client 122, a full client 123 and a full client 124, receive various content from a content delivery network 121. A light client 125 can receive the content from any of full client 121, full client 122, full client 123 or full client 124. While light client 125 receives content from a full client, as more fully discussed above, authorization to use protected content is obtained from a rights server.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A rights manager comprising:
a database that contains information pertaining to a content user, the information including a separate identification for each device of a content user authorized to use content; and,
a rights server that interacts with the database, so that when the rights server receives a request for authorization to use content by a first device of a content user, the rights server matches a first identification stored on the first device with identification information stored in the database to identify the first device and the content user;
wherein when the rights server grants the authorization, the first identification is replaced with a new identification, the new identification being different than the first identification, the new identification being stored in the content user database and in the first device, the new identification being used to identify the first device and the content user in a next interaction between the first device and the rights server.

2. A rights manager as in claim 1 wherein the authorization is a limited authorization for a set period of time.

3. A rights manager as in claim 1 wherein the authorization is a limited authorization for a set number of plays of the content.

4. A rights manager as in claim 1 wherein the content is a Windows Media Video (WMV) file.

5. A rights manager as in claim 1 wherein the first device stores the first identification and the new identification within an internet cookie.

6. A system that provides authorization to use content, the system comprising:
a client device for a content user, the client device storing a first client identifier; and,
a rights manager, the rights manager including a database that contains information pertaining to the content user, the information including the first client identifier;
wherein when authorization to use the content does not currently reside on the client device and the content user attempts to use the content on the client device, the client device requests from the rights manager authorization to use the content, the rights manager uses the first client identifier from the client device to identify the client device, and when the authorization to use the content is granted to the client device, the first identification is replaced with a new identification, the new identification being different than the first identification, the new identification being stored in the database and in the client device, the new identification being used to identify the client device in a next interaction between the client device and the rights manager.

7. A system as in claim 6 additionally comprising:
a second client device for a content user, the client device including a downloading rights management application in which is stored a second client identifier;
wherein when authorization to use the content does not currently reside on the second client device and the content user attempts to use the content on the second client device, the second client device requests from the rights manager authorization to use the content, the rights manager uses the second client identifier from the second client device to identify the second client device, and when the authorization to use the content is granted to the second client device, the second identification is not replaced.

8. A system as in claim 7 wherein any authorization granted to the client device is a limited authorization and any authorization granted to the second client device is an unlimited authorization.

9. A system as in claim 6 wherein the content is a Windows Media Video (WMV) file.

10. A system as in claim 6 wherein the client device stores the first identification and the new identification within an internet cookie.

11. A device that uses protected content, the device comprising:
a media player that plays the protected content; and,
a memory location that stores a first client identifier;
wherein when authorization to use the content does not currently reside on the device and a content user attempts to use the content on the media player, the device requests from a rights manager authorization to use the content, the rights manager uses the first client identifier from the device to identify the device, and when the authorization to use the content is granted to the device, the first identification is replaced with a new identification, the new identification being different than the first identification, the new identification being stored in a database within the rights manager and in the device, the new identification being used to identify the device in a next interaction between the device and the rights manager.

12. A system as in claim 11 wherein the authorization is an authorization limited by a period of time.

13. A system as in claim 11 wherein the media player is a Windows Media Player.

14. A system as in claim 11 wherein the memory location is within an internet cookie.

15. A method by which a rights manager grants authorization to use content, the method comprising:
receiving a request from a client device for authorization to use the content; and,
when the rights manager receives a client identifier from the client device, proceeding as follows:
using the client identifier to identify the client device and determine what access rights the client device has for the content, and
when the client device has access right to the content, returning to the client device a limited authorization to use the content and a new client identifier for the client device, the new client identifier being used to identify the client device in a next interaction between the client device and the rights manager.

16. A method as in claim 15 additionally comprising:
when the rights manager does not receive a client identifier from the client device, proceeding as follows:
obtaining information from a content user on the client device that identifies the client device as a client of the content user,
using the information to identify the content user and determine what access rights the client device is allowed to have for the content, and
when the client device is allowed to have access to the content, returning to the client device a limited authorization to use the content and a new client identifier for the client device, the new client identifier being used to identify the client device in a next interaction between the client device and the rights manager.

17. A method as in claim 16 wherein when the rights manager determines what access rights the client device is allowed to have for the content, the rights manager determines whether a limit of the number of clients for the content user will be exceeded if the rights manager authorizes the client device to use the content.

18. A method as in claim 16 wherein the client device obtains the content from another client device of the content user.

19. A method as in claim 15 wherein the client device stores the client identifier and then the new client identifier within an internet cookie.

20. A method by which a rights manager protects against unauthorized use of content:
when an unauthorized user of content uses a first identification obtained from a client device to obtain authorization to use content on an unauthorized client, returning to the unauthorized client a limited authorization to use the content and a new identification for the unauthorized client, the new identification being used to identify the unauthorized client in a next interaction between the unauthorized client and the rights manager; and,
when the client device next requests authorization to use content, in response to the first identification, performing the following:
obtaining information from a content user on the client device that identifies the client device as a client of the content user, and
allowing the content user to invalidate the new identification so that when the limited authorization expires the unauthorized client will be denied requests for authorization to use the content.

21. A method by which a client device obtains authorization to use content, the method comprising:
requesting from a rights manager authorization to use the content; and,
when a client identifier exists on the client device, proceeding as follows:
providing the rights manager with the client identifier, the rights manager using the client identifier to identify the client device and determine what access rights the client device has for the content, and
when the client device has access right to the content, receiving from the rights manager a limited authorization to use the content and a new client identifier for the client device, the new client identifier being used to identify the client device in a next interaction between the client device and the rights manager.

22. A method as in claim 21 additionally comprising:
when a client identifier exists on the client device, proceeding as follows:
providing to the rights manager information from a content user on the client device that identifies the client device as a client of the content user, the rights manager using the information to identify the content user and determine what access rights the client device is allowed to have for the content, and
when the client device is allowed to have access to the content, receiving from the rights manager a limited authorization to use the content and a new client identifier for the client device, the new client identifier being used to identify the client device in a next interaction between the client device and the rights manager.

23. A method as in claim 22 wherein the client device obtains the content from another client device of the content user.

24. A method as in claim 21 wherein the client device stores the client identifier and then the new client identifier within an internet cookie.

25. A rights manager comprising:
a means for storing information pertaining to a content user, the information including a separate identification for each device of a content user authorized to use content; and,
means for granting authorization, the means for granting authorization interacting with the means for storing information so that when the means for granting authorization receives a request for authorization to use content by a first device of a content user, the means for granting authorization matches a first identification stored on the first device with identification information stored in the means for storing information to identify the first device and the content user;
wherein when the means for granting authorization grants the authorization, the first identification is replaced with a new identification, the new identification being different than the first identification, the new identification being stored in the means for storing information and in the first device, the new identification being used to identify the first device and the content user in a next interaction between the first device and the means for granting authorization.
